(19) United States
(12) Patent Application Publication
(10) Pub. No.: US 2017/0004568 A1
(43) Pub. Date: Jan. 5, 2017

(54) RETAILER LINKED PERSONALIZED SHOPPING ASSISTANT

(71) Applicant: Alexander J. C. Radner, Huntington Woods, MI (US)

(72) Inventor: Alexander J. C. Radner, Huntington Woods, MI (US)

(21) Appl. No.: 15/200,302

(22) Filed: Jul. 1, 2016

Related U.S. Application Data
(60) Provisional application No. 62/188,150, filed on Jul. 2, 2015.
(60) Provisional application No. 62/193,635, filed on Jul. 17, 2015.

(51) Int. Cl. G06Q 30/06; G06F 3/0482; G06F 3/0488; G06F 3/0484; G06T 13/40; G06F 3/0481

(52) U.S. Cl. CPC G06Q 30/0643; G06T 13/40; G06F 3/04815; G06F 3/04883; G06F 3/04845; G06F 3/0482; G06F 3/04842; G06T 2207/10004

(57) ABSTRACT

An application (app) is provided for a virtual online shopping experience utilizing a user generated three dimension (3D) proportional avatar of themselves for the selection and purchase of clothing items and accessories from participating retailers. A user accesses the app on their smartphone, tablet, or portable computing device via an account, which may be password protected. The user is instructed to take a series a photos of themselves with their device from varying perspectives, with the help of a second person as the photographer or alone with a selfie stick. The portable computing device may also be stationary and the user can rotate in front of the camera to collect data for generating a 3D avatar. The app utilizes the series of photos taken to generate a 3D avatar that has the proportions of the user in order to select the proper sizes and fit for clothing and accessories.

### CROSS REFERENCE TO RELATED APPLICATIONS

This application claims priority benefit of U.S. Provisional Application Ser. No. 62/188,150 tiled 2 Jul. 2015, and U.S. Provisional Application Ser. No. 62/193,635 filed 17 Jul. 2015; the contents of which are hereby incorporated by reference.

### FIELD OF THE INVENTION

The present invention generally relates to Internet based retailing, and more specifically to a personalized virtual shopping for clothing items using a personalized proportional avatar.

### BACKGROUND OF THE INVENTION

Internet based retailing, commonly referred to as on-line shopping has gained wide spread acceptance for all manner of items ranging from electronics, collectables, and food, to clothing. However, lower levels of overall customer satisfaction and higher levels of customer returns have been associated with clothing items, since clothing items generally need to be tried on by the user to ensure a proper fit, as well as to visualize how the wearer will look in the purchased clothing.

Recent advancements in body scanners and digital imaging have allowed for the creation of proportional three dimensional (3D) full body representations or avatars of scanned subjects. However, the use of avatars in the online retailing of clothing and clothing accessories has not been generally implemented since the body scans require a subject to visit a location where the body scanner is available.

Thus there is a need for a home based method for obtaining a body scan that allows a user to create a three dimensional proportional avatar for use in the selection of clothing and accessories in an online environment

### SUMMARY OF THE INVENTION

A virtual shopping application (app) includes a graphical user interface (GUI) for displaying a first rack for collecting selected items from one or more retailers, a second rack for holding items ready for purchase, an avatar with user body proportions for sizing and wearing the selected items, a purchasing button to pay for an item, and a wardrobe made up of purchased items.

A non-transitory computer-readable medium for a virtual shopping application (app) is provided that includes instructions stored thereon, that when executed on a processor, perform the steps of supplying a graphical user interface (GUI). The GUI displays a first rack for collecting selected items from one or more retailers, a second rack for holding items ready for purchase, an avatar for wearing the selected items, a purchasing button to pay for item, and a wardrobe made up of purchased items.

A system for virtual shopping includes a computer server networked to one or more end user devices, where the computer server is configured to run a non-transitory computer readable medium for virtual shopping. The non-transitory computer readable medium has instructions stored thereon, that when executed on a processor, perform the steps of: providing an application (app) to the one or more end user devices, where the app generates a graphical user interface (GUI) for displaying: a first rack for collecting selected items from one or more retailers; a second rack for holding items ready for purchase; an avatar for wearing the selected items; a purchasing button to pay for item; and a wardrobe made up of purchased items.

### BRIEF DESCRIPTION OF THE DRAWINGS

The present invention is further detailed with respect to the following drawings that are intended to show certain aspects of the present invention, but should not be construed as a limit on the practice of the present invention.

FIG. 1 is screenshot of a clothing retailer webpage for the selection of items that may be loaded into a personal account of a shopper for use with a personalized avatar for customer selection and purchase of selected items in accordance with embodiments of the invention;

FIG. 2 is a screenshot of a graphical user interface (GUI) for selection of items and use of the personalized avatar to make purchase decisions in accordance with embodiments of the invention;

FIG. 3 is a flow diagram which illustrates an exemplary process which uses a personalized avatar to make purchasing decisions on items selected from affiliated retailers in a virtual environment in accordance with embodiments of the invention; and

FIG. 4 is a schematic diagram illustrating an overall view of communication devices, computing devices, and mediums for implementing embodiments of the invention.

### DETAILED DESCRIPTION OF THE INVENTION

The present invention has utility as a virtual online shopping experience utilizing a user generated three dimension (3D) proportional avatar of themselves for the selection and purchase of clothing items and accessories from participating retailers. In specific inventive embodiments, the user accesses the inventive application (app) on their smartphone, tablet, or portable computing device. The inventive application may instruct the user to establish an account, which may require a unique security password. The user is then instructed to take a series a photos of themselves with their device from varying perspectives, with the help of a second person as the photographer or alone with a selfie stick. The portable computing device may also be stationary and the user can rotate in front of the camera to collect data for generating a 3D avatar. The inventive app utilizes the series of photos taken of the user to generate a three dimensional 3D avatar that has the proportions of the user. The proportions of the avatar may be used to select the proper sizes and fit for clothing and accessories. With the establishment of a user account and the creation of the personalized avatar, the user is now ready to make virtual selections of clothing and accessory items from participating retailers that may be accessed from embodiments of the personalized shopping app.

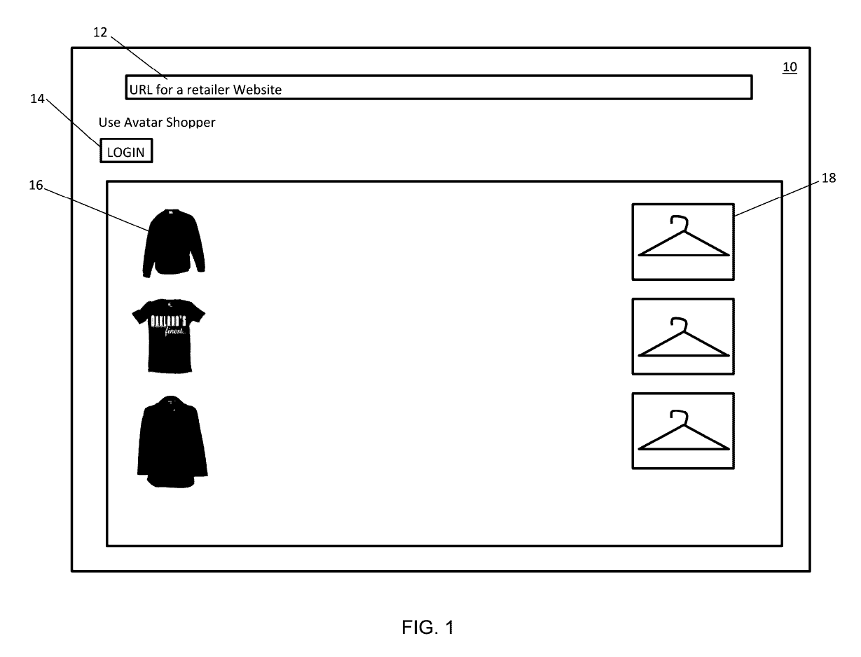

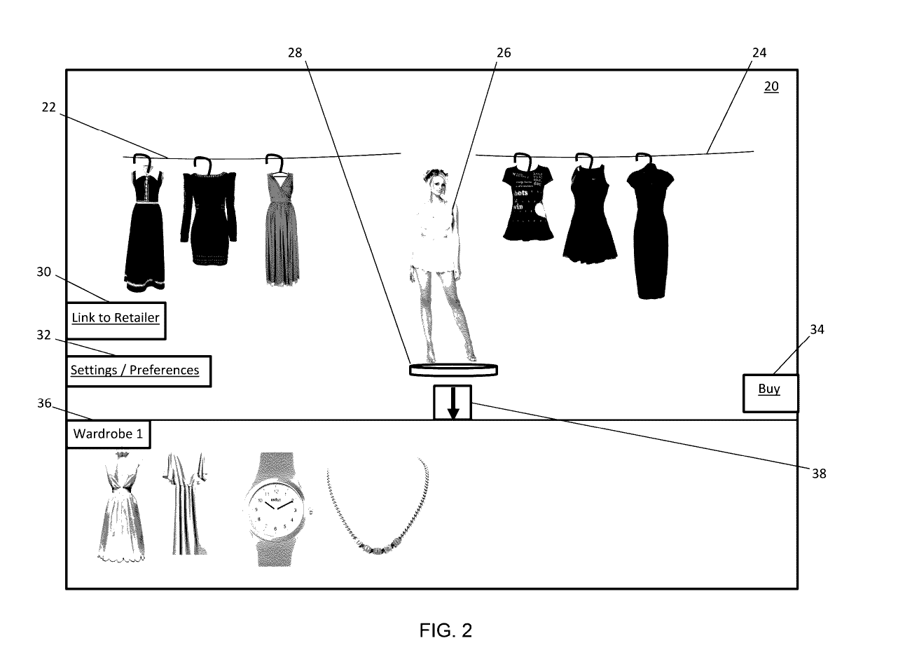

Referring now to the figures, FIG. 1 is a sample screenshot 10 of a clothing retailer webpage 12 for the selection of items 16 that may be loaded into a personal account of a shopper for use with a personalized avatar 26 for customer selection and purchase of selected items in accordance with embodiments of the invention. The user may access their account from the retailer webpage via login button 14. The user may select items 16 to “try on” in the virtual environment of the inventive app via one of the “add to rack” buttons 18. The selected clothing and accessory items are placed on the “try on rack” 22 as shown in FIG. 2.

FIG. 2 is a screenshot 20 of a graphical user interface (GUI) of the inventive app for selection of items 16 and use of the personalized avatar 26 to make purchase decisions in accordance with embodiments of the invention. As shown a first rack serves a try on rack 22 which is used to collect items 16 selected from various retailers that are accessible from the app, or have a link to login 14 the app on the retailers' website as shown in FIG. 1. A second rack is used to collect and hold items 24 that the user wishes to purchase and functions similar to a shopping cart. It should be noted that the app is designed for use on touchscreen devices, so swipes of the screen may be used to move items between the racks (22, 24) and on to the avatar 26. For example, a user may swipe right to add cloths or accessories 16 to the avatar 26, as well as drag items from the racks (22, 24) or wardrobe 36 to try on the avatar 26. The personalized and proportioned avatar 26 is positioned on a podium 28 that may have up to a full 360 degree rotation for varying views of the rotating avatar. The podium 28 may be spun back and forth by swiping the display (right, left) in the vicinity of the podium 28. Spreading and pinching of the user's fingers enlarges or reduces the avatar 26 on the touchscreen display device. The wardrobe 36 is customizable by the user, and may include items (cloths, jewelry, shoes, wigs) previously purchased by the user. The down button 38 may be used to close a selected wardrobe, and to enlarge the avatar on the display screen. The link to retailer button 30 brings up a pull down menu of available or participating retailers. The buy button 34 is used to purchase items that have been placed on the collect and hold rack 24. A link to popular online pay services or a pull down to supply credit or debit card information appears in response to the selection of the buy button 34. Once the items are purchased, the user is asked to select a wardrobe to place the purchased items in. The settings and preferences button 32 may be used by the user to edit personal information, payment information, display formats, avatar preferences, and other operational parameters.

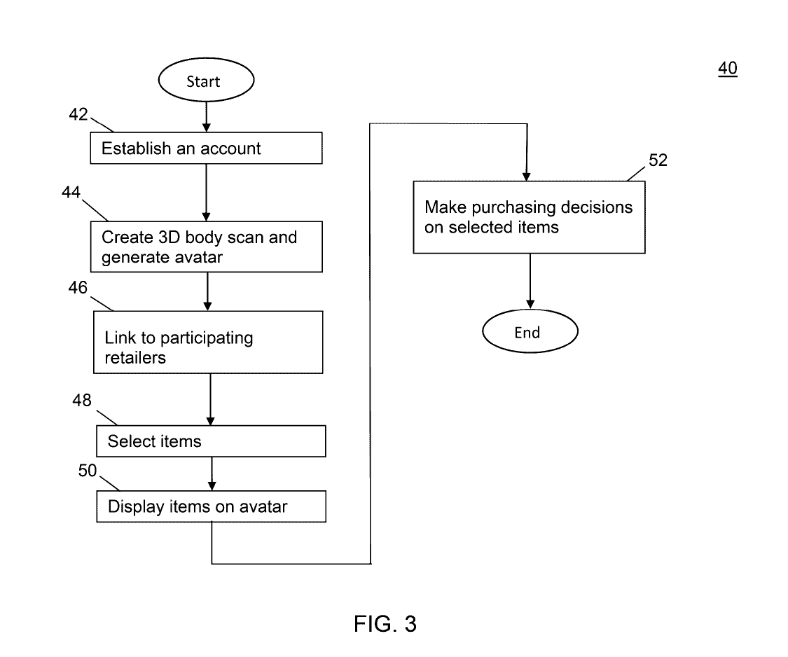

FIG. 3 is a flow diagram which illustrates an exemplary process 40 which uses the personalized avatar 26 to make purchasing decisions on items selected from affiliated retailers in a virtual environment in accordance with embodiments of the invention. The process starts with the user establishing an account with the app (step 42) and the creation of a 3D avatar (step 44). Subsequently, the user may link to participating retailers (step 46) to select items (step 48) for display on the avatar (step 50) for making purchasing decisions on selected items (step 52).

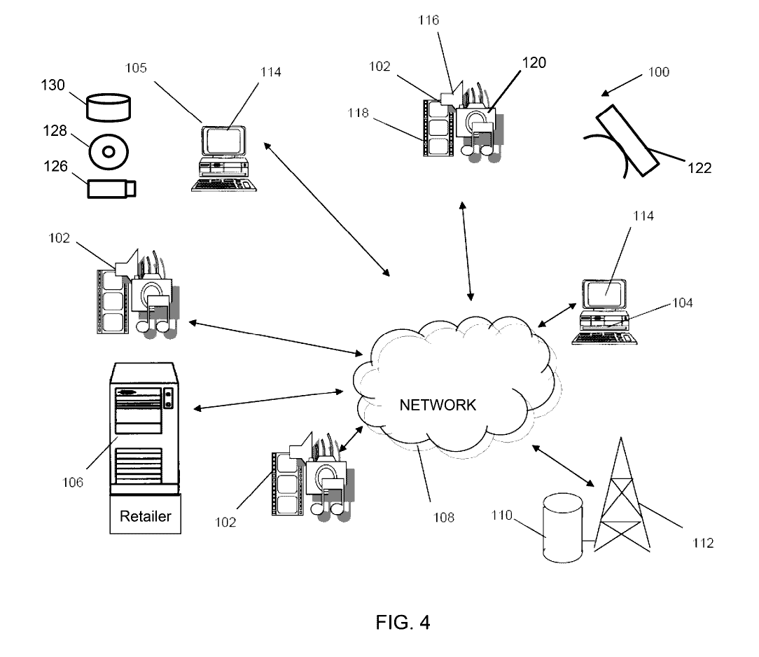

FIG. 4 is a schematic diagram illustrating an overall view of communication devices, computing devices, and mediums for implementing the virtual shopping platform according to embodiments of the invention. The elements of the embodiments of FIGS. 1 - 3 are included in the networks and devices of FIG. 4.

The system 100 includes multimedia devices 102 and desktop computer devices 104 configured with display capabilities 114 and processors for executing instructions and commands. The multimedia devices 102 are optionally mobile communication and entertainment devices, such as cellular phones, tablets, and mobile computing devices that in certain embodiments are wirelessly connected to a network 108. The multimedia devices 102 typically have video displays 118 and audio outputs 116, as well as photographic capabilities 120. The multimedia devices 102 and desktop computer devices 104 are optionally configured with internal storage, software, and a graphical user interface (GUI) for carrying out elements of the platform according to embodiments of the invention. The network 108 is optionally any type of known network including a fixed wire line network, cable and fiber optics, over the air broadcasts, satellite 122, local area network (LAN), wide area network (WAN), global network (e.g., Internet), intranet, etc. with data/Internet and remote storage capabilities as represented by server 106. Communication aspects of the network are represented by cellular base station 110 and antenna 112. In a preferred embodiment, the network 108 is a LAN and each remote device 102 and desktop device 104 executes a user interface application (e.g., Web browser) to contact the server system 106 through the network 108. Alternatively, the remote devices 102 and 104 may be implemented using a device programmed primarily for accessing network 108 such as a remote client. The network 108 may be accessed by the user during a virtual shopping experience.

The software for the platform, of embodiments of the invention, may be resident on a USB thumb or flash drive 126, CD or DVD 128, or an external hard drive 130 for connection to desktop or laptop computers 104, or stored within the server 106 or cellular base station 110 for download to an end user. Server 106 may implement a cloud-based service for implementing embodiments of the platform with a multi-tenant database for storage of separate client data.

The foregoing description is illustrative of particular embodiments of the invention, but is not meant to be a limitation upon the practice thereof. The following claims, including all equivalents thereof, are intended to define the scope of the invention

1. A virtual shopping application (app) comprising:
a graphical user interface (GUI) for displaying:
a first rack for collecting selected items from one or more retailers;
a second rack for holding items ready for purchase;
an avatar for wearing the selected items;
a purchasing button to pay for item; and
a wardrobe made up of purchased items.

2. The virtual shopping app of claim 1 wherein the avatar is a three dimensional proportional representation of the user.

3. The virtual shopping app of claim 1 wherein the GUI is touchscreen sensitive and accepts commands and actions via the user touching or swiping a screen of a user device.

4. The virtual shopping app of claim 1 wherein the app is accessible on a smartphone, a tablet, a computer, or a portable computing device.

5. The virtual shopping app of claim 1 wherein the avatar is positioned on a podium that has a full 360 degree rotation for varying views for rotating the avatar.

6. The virtual shopping app of claim 1 wherein the wardrobe is customizable by the user with items previously purchased by the user.

7. The virtual shopping app of claim 1 wherein the GUI further comprises a link to retailer button that brings up a pull down menu of available or participating retailers.

8. The virtual shopping app of claim 1 wherein in response to the selection of the purchasing button a link to popular online pay services or a pull down to supply credit or debit card information appears.

9. The virtual shopping app of claim 1 wherein the GUI further comprises a settings and preferences button to edit personal information, payment information, display formats, avatar preferences, and other operational parameters.

10. A non-transitory computer-readable medium for a virtual shopping application (app), comprising instructions stored thereon, that when executed on a processor, perform the steps of:
supplying a graphical user interface (GUI) for displaying:
a first rack for collecting selected items from one or more retailers;
a second rack for holding items ready for purchase;
an avatar for wearing the selected items;
a purchasing button to pay for item; and
a wardrobe made up of purchased items.

11. The non-transitory computer-readable medium of claim 10 further comprising a set of instructions for forming the avatar as a proportional three dimensional representation of a user, the set of instructions comprising:
instructing the user to take a series a photos of themselves with their device from varying perspectives; and
wherein the app uses the series of photos taken of the user to generate the proportional three dimensional avatar.

12. The non-transitory computer-readable medium of claim 10 further comprising a set of instructions for forming the avatar as a proportional three dimensional representation of a user, the set of instructions comprising:
instructing the user to rotate in front of their stationary device while the device takes a series of photos; and
wherein the app uses the series of photos taken of the user to generate the proportional three dimensional avatar.

13. The non-transitory computer-readable medium of claim 10 wherein the GUI is touchscreen sensitive and accepts commands and actions via a user touching or swiping a screen of a user device.

14. The non-transitory computer-readable medium of claim 10 wherein in response to the selection of the purchasing button a link to popular online pay services or a pull down to supply credit or debit card information appears.

15. The non-transitory computer-readable medium of claim 10 wherein the GUI further comprises a settings and preferences button to edit personal information, payment information, display formats, avatar preferences, and other operational parameters.

16. A system for virtual shopping, said system comprising:
a computer server networked to one or more end user devices, where said computer server is configured to run a non-transitory computer readable medium for virtual shopping, comprising instructions stored thereon, that when executed on a processor, perform the steps of:
providing an application (app) to the one or more end user devices, where the app generates a graphical user interface (GUI) for displaying:
a first rack for collecting selected items from one or more retailers;
a second rack for holding items ready for purchase;
an avatar for wearing the selected items;
a purchasing button to pay for item; and
a wardrobe made up of purchased items.

17. The virtual shopping system of claim 16 wherein the one or more user devices comprise: a smartphone, a tablet, a computer, or a portable computing device.

18. The virtual shopping system of claim 16 wherein the avatar is a proportional three dimensional representation of a user.

19. The virtual shopping system of claim 16 wherein the GUI is touchscreen sensitive and accepts commands and actions via the user touching or swiping a screen of one or more end user devices.

20. The virtual shopping system of claim 16 wherein the avatar is positioned on a podium that has a full 360 degree rotation for varying views for rotating the avatar.
